(19) United States
(12) Patent Application Publication
(10) Pub. No.: US 2003/0090112 A1
(43) Pub. Date: May 15, 2003

(54) Pipe joint assembly

(76) Inventors: Brad Baughman, Paulding, OH (US); Helmut Linsgeseder, Saline, MI (US)

Correspondence Address: MARSHALL & MELHORN, FOUR SEAGATE, EIGHT FLOOR, TOLEDO, OH, 43604, US

(21) Appl. No.: 09/990,825

(22) Filed: Nov. 14, 2001

(51) Int. Cl. F16L 17/00

(52) U.S. Cl. 285/903; 285/374

(57) ABSTRACT

A pipe joint assembly joins two double wall pipe sections together. The pipe joint assembly includes a first pipe section having at least one double wall corrugation on an end portion, a second pipe section having at least one double wall corrugation on an end portion and a joint formed by locating the first pipe section end portion and the second pipe section end portion in an overlapping relationship. The pipe joint assembly substantially increases the strength of the joint relative to conventional pipe assemblies.

### BACKGROUND OF THE INVENTION

1. Field of the Invention

The present invention relates to a pipe joint assembly. More particularly, the present invention relates to a pipe joint assembly for joining two double wall pipe sections. Most particularly, the present invention relates to a pipe joint assembly for joining first and second pipe sections having double wall corrugations with a joint formed from the first and second sections.

2. Discussion of the Related Art

In the related art, there are essentially two methods for joining two corrugated pipes together. The first method is represented in U.S. Pat. No. 4,795,197 to Kaminski et al. In Kaminski, two corrugated pipes are joined by locating the end portions of the pipes within a common sleeve. The sleeve attaches to the outside surfaces of both end portions. The sleeve increases the outside diameter of the resulting length of pipe thereby requiring additional clearance or digging around the coupling to accommodate it in a trench. Furthermore, the coupling does not have a smooth interior surface which may cause interruption and turbulence in fluids as they pass through the coupling.

The second method is represented in U.S. Pat. No. 6,126,209 to Goddard. The Goddard patent teaches two corrugated sections of pipe wherein one section has a male portion and the second section has a female portion. The male and female portions combine to form an in-line bell which joins the two sections. The joint created in Goddard, however, is not particularly strong, as the female portion is a single wall construction having corrugations that are many times smaller than the corrugations of the male portion.

Another disadvantage of the Goddard reference is that the formation of the male and female portions within a section of pipe increases the time it take to produce the pipe. The male and female portions must be extruded during the production of the pipe and the extrusion process is significantly slower than the formation of a pipe having regular corrugations.

Also, the method of producing the joint in the Goddard reference results in wasted material. As mentioned above, the male and female portions are extruded within a section of the pipe itself. This method results in a portion of pipe between the male and female portions which is unusable and, therefore it must be removed and discarded.

Two problems associated with both types of known pipe assemblies is the formation of a relatively strong joint that does not increase the outside diameter of the pipe joint assembly and locating a water tight, silt tight and/or leak resistant seal between the portions to be joined.

Therefore, it would be advantageous to form a pipe joint assembly requiring a minimum of parts to join two pipe sections securely and strongly together in a watertight, silt tight, and/or leak resistant manner. Additionally, it would be advantageous to produce a pipe joint assembly without significantly increasing the outside diameter or decreasing the inside diameter of the pipe sections to be joined. It would also be advantageous to form a pipe joint assembly wherein the formation of the joining portions does not slow production of the corrugated pipe or waste pipe material.

### SUMMARY OF THE INVENTION

The present invention provides a pipe joint assembly for joining two sections of dual wall corrugated pipe together. The pipe joint assembly has a first pipe section having a first portion with double wall corrugations of a first height and double wall corrugations of a second height located on an end portion. The pipe joint assembly also has a second pipe section having a first portion with double wall corrugations of a first height and double wall corrugations of a second height located on an end portion.

The first height corrugations on the first and second pipe sections are substantially similar in height. Preferably, the second height corrugations on the first and second portions are substantially similar in height. In one most preferred embodiment, the second height corrugations are approximately one half the height of the first corrugations.

A quadruple walled joint, or cuff, joining the two sections is created by frictionally locating the end portion of the first section in an overlapping relationship with the end portion of the second section. A friction fit between the respective end portions of the sections allows users to efficiently connect sections together without additional parts or fittings.

The joint has approximately the same outside diameter as the outside diameters of the first and second pipe sections. A substantially constant outside diameter allows the joint and pipe sections to be located in a trench having substantially the same diameter, thereby reducing the amount and difficulty of digging required. The overlapping nature of the double walled end portions at the joint renders the joint relatively strong compared to prior art joints or cuffs.

One or more gaskets may be located between the end portions to make the joint silt tight and/or leak resistant.

### BRIEF DESCRIPTION OF THE DRAWINGS

The above, as well as other advantages of the present invention, will become readily apparent to those skilled in the art from the following detailed description of the preferred embodiment when considered in light of the accompanying drawings in which:

FIG. 1 is a sectional view of a construction embodying the present invention; and

FIG. 2 is a sectional view of the construction shown in FIG. 1;

FIG. 3 is a side view of the construction shown in FIG. 1; and

FIG. 4 is a sectional view of an alternative embodiment of the present invention.

### DETAILED DESCRIPTION OF A PREFERRED EMBODIMENT

It is to be understood that the specific structures and processes illustrated in the attached drawings and described in the following description are simply exemplary embodiments of the inventive concepts defined in the appended claims. Hence, specific dimensions and other physical characteristics relating to the embodiments disclosed herein should not be considered as limiting, unless the claims expressly state otherwise.

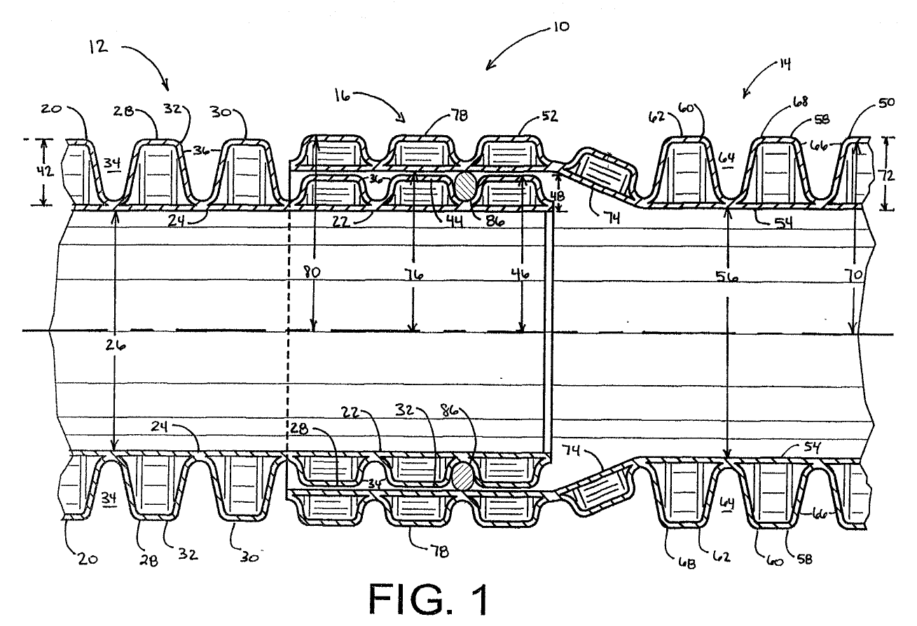

Referring now to the drawings, FIG. 1 depicts a pipe joint assembly 10 having a first pipe section 12, a second pipe section 14 and a joint 16 defined therebetween. The pipe joint assembly 10 can be constructed substantially of polyethylene, however, other materials known by those skilled in the art, such as polyvinylchoride, polypropylene or other polyolefins, are within the scope and spirit of this invention.

In a preferred embodiment, the pipe joint assembly 10 has an overall outside diameter 18. The outside diameter 18 is substantially constant over the first pipe section 12, the second pipe section 14 and the joint 16.

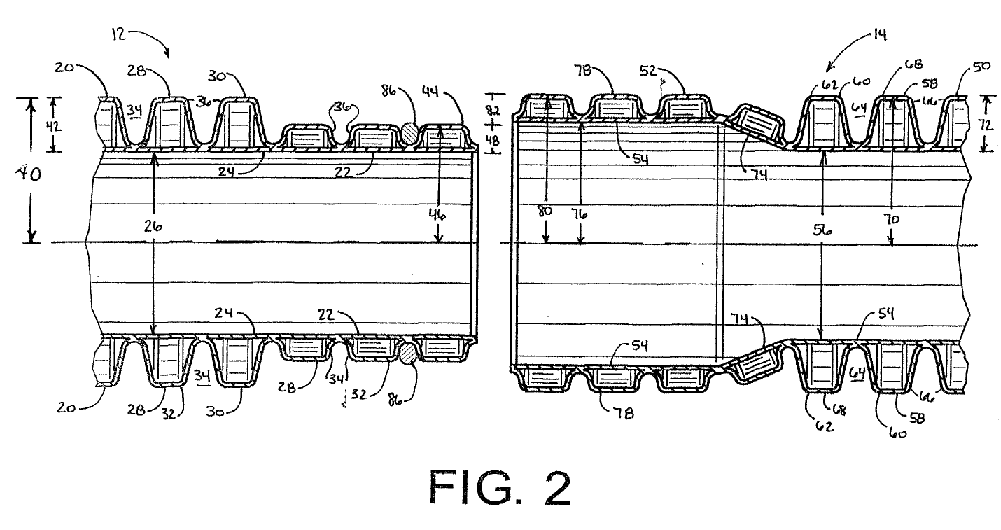

As depicted in FIGS. 1 and 2, the first pipe section 12 preferably has a first portion 20 and an end portion 22. The first portion 20 and the end portion 22 are connected by a first wall 24. The first wall 24 is located along an inside radius 26 of the pipe joint assembly 10. Preferably, the inside radius 26 of the first wall 24 is substantially constant, or circular, along the length of first portion 20 and the end portion 22. The constant radius 26 of the first wall 24 assists fluid flowing within the first pipe section 12 to flow without interruption or turbulence. Although the first wall 24 is preferably a smooth wall with a constant radius 26, other geometries, such as elliptical, which promote a fluid flow without interruption or turbulence are well within the scope and spirit of the invention.

Preferably, a plurality of corrugations 28 integrally formed with the first wall 24 and extending radially outward from the first wall 24 forms a second or double, wall 30 as depicted in FIGS. 1 and 2. The corrugations 28 are typical of those known by those skilled in the art and have at least one crest 32 and at least one valley 34 connected by at least two side walls 36.

The second wall 30, proximate the first portion 20, has a plurality of corrugations 38 having a radius 40 and a first height 42. In the preferred embodiment, the second wall 30, proximate the end portion 22, has at least one corrugation 44 having a radius 46 and a second height 48. In a more preferred embodiment depicted in FIGS. 1 and 2, the second wall 30 proximate the end portion 22 has a plurality of corrugations 44 of the radius 46 and the second height 48. The second height 48 corrugations are most preferably approximately one-half the height of the first height 42 corrugations.

As shown in FIGS. 1 and 2, the second pipe section 14 also has a first portion 50 and an end portion 52. The first portion 50 and the end portion 52 are connected by a third wall 54. Proximate the first portion 50, the third wall 54 has a substantially constant inside radius 56. Although the third wall 54 is preferably a smooth wall with a constant radius 56, other geometries, such as elliptical, which promote a fluid flow without interruption or turbulence are well within the scope and spirit of the invention. The radius 56 of the third wall 54 is substantially identical to the radius of the first wall 26.

Preferably, a plurality of corrugations 58 are integrally formed with the third wall 54 and extend radially outward from the third wall 54 to form a fourth, or double, wall 60, as depicted in FIGS. 1 and 2. The corrugations 58 formed with the third wall 54 are typical of those known by those skilled in the art having at least one crest 62 and at least one valley 64 connected by at least two side walls 66.

As shown in FIGS. 1 and 2, the fourth wall 60, proximate the first portion 50, has a plurality of corrugations 68 having a maximum radius 70 and a first height 72. The corrugations 38, 68 of both of the first portions 20, 50 of the first 12 and second 14 sections of the pipe joint assembly 10 are substantially identical in shape, height and radius.

In the preferred embodiment shown in FIGS. 1 and 2, a transition 74 between the first portion 50 and the end portion 52 of the second section 14 locates the third wall 54 proximate the end portion 52 radially outward from the second wall 30. In a more preferred embodiment, the transition 74 locates the third wall 54 proximate the end portion 52 to a radius 76. In a most preferred embodiment, the transition 74 locates the third wall 54 proximate the end portion 52 to the radius 76 which is slightly greater than the radius 40 of the second wall 30.

The fourth wall 60, proximate the end portion 52, has at least one corrugation 78 having a maximum radius 80 and a second height 82. In the preferred embodiment shown in FIGS. 1 and 2, the fourth wall 60 proximate the end portion 52 has a plurality of corrugations 78 having the radius 80 and the second height 82.

Preferably, the corrugations 44, 78 of the end portions 22, 52 of the first 12 and second 14 sections of the pipe joint assembly 10 are substantially identical in shape and height. Corrugations 44, 78 having substantially identical shapes and heights facilitate the joining of the first 12 and second 14 sections, as will be described in greater detail below.

The slightly greater radius 52 of the third wall 54 allows the end portion 52 of the second section 14 to be slid over the end portion of the first section so that the end portion 22 of the second section 14 is located radially outward of, and substantially overlaps, the end portion 22 of the first section 12. In this orientation, the third wall 54 is located radially outward of, and substantially overlaps, both of the corrugations 44 of the second wall 30, as depicted in FIG. 1.

The slightly greater radius 56 of the third wall 54 compared to the radius 40 of the second wall 30 results in the third wall 54 and the second wall 30 frictionally engaging each other. The frictional engagement of the second 30 and third 54 walls creates the joint 16 capable of holding the first 12 and second 14 sections together.

The second 30 and third 54 walls may also be joined by alternative mechanical means without departing from the spirit or scope of the present invention. The mechanical means may include, but is not limited to, clamps, cleats, or locking tabs (not shown). The clamps would be circumferentially located about the third wall 54 and when tightened about the third wall 54 move the third wall 54 into gripping contact with the second wall 30. The clamps would not appreciably increase an overall outside diameter 84 of the pipe joint assembly 10.

Cleats, or locking tabs, may extend from either the second wall 30 or the third wall 54. Cleats located on the second wall 30 are received in locking devices located on the third wall 54. Similarly, cleats located on the third wall 54 may be received in locking devices located on the second wall 30.

In the engaged orientation depicted in FIG. 1, the radius 40 of the second wall 30 adjacent the first portion 20, the radius 80 of the fourth wall 60 adjacent the end portion 52 and the radius 70 of the fourth wall 60 adjacent the first portion 50 are substantially identical. Therefore, the overall outside diameter 18 of the first 12 and second 14 pipe sections in the engaged orientation is substantially constant along the length of the joined sections.

Similarly, in the engaged orientation, the radius 26 of the first wall 24 and the radius 56 of the third wall 54 adjacent the first portion 50 of the second section 14 are substantially identical. Therefore, in the engaged orientation, the first and second pipe sections have a substantially constant overall inside radius 18 along its length.

In the preferred embodiment depicted in FIGS. 1 and 2, at least one gasket 86 is located between the second 30 and third 54 walls to make the joint 16 silt and/or leak resistant. In a more preferred embodiment, the at least one gasket 86 is located in the valley 34 between the at least one corrugation 44 of the end portion 22 of the first section 12. In a most preferred embodiment, the gasket 88 is an elastomeric O-ring.

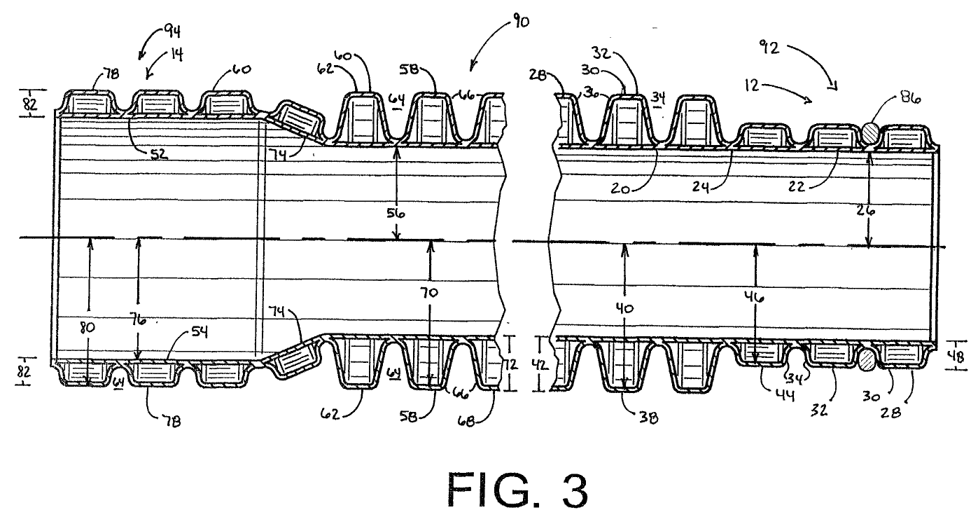

FIG. 3 depicts a pipe 90 having a first end 92 and a second end 94. The first end 92 is constructed as the first pipe section 12 disclosed above and the second end 94 is constructed as the second pipe section 14 disclosed above. Although it has been disclosed that the first end 92 is constructed as the first pipe section 12 and the second end 94 is constructed as the second pipe section 14, it should be understood that the first end 92 may also be constructed as the second pipe section 14 and the second end 94 may be constructed as the first pipe section 12 without departing from the scope or spirit of the invention.

Pipe 90 is connected to other pipes (not shown) having a substantially identical construction. Pipe 90 is connected to another pipe by connecting the first pipe section 12 with a second pipe section, identical to the second pipe section 14 disclosed above, of an adjacent pipe. Similarly, pipe 90 is connected to another pipe by connecting the second pipe section 14 with a first pipe section, identical of the first pipe section 12 disclosed above, of an adjacent pipe. In this manner a plurality of pipes may be connected together having all of the advantages of the assembly disclosed above.

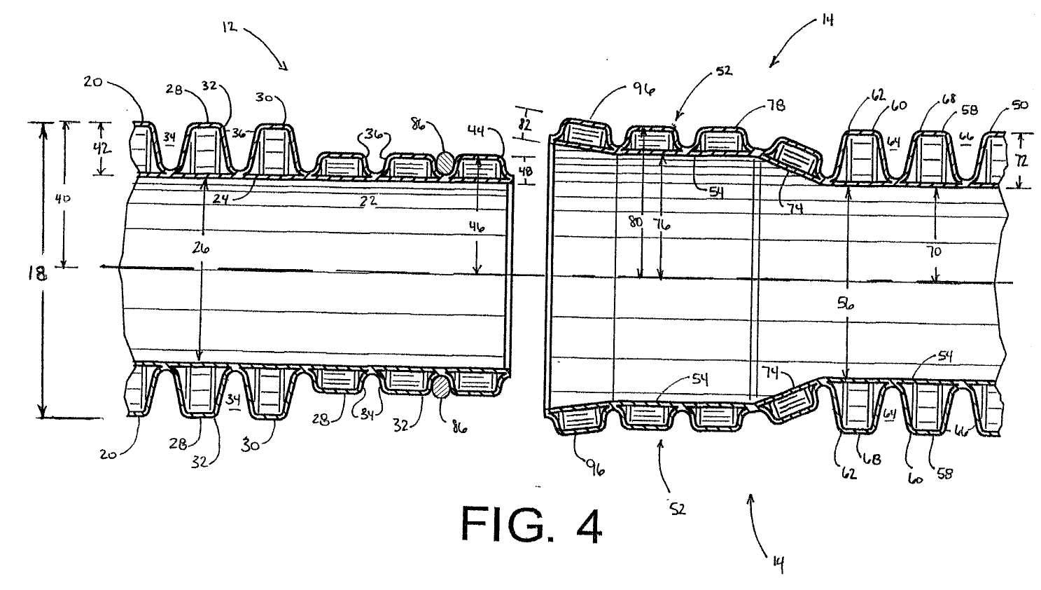

FIG. 4 depicts another alternative embodiment wherein one or more corrugations 96 on the end portion 52 of the second pipe section 14 are flared outwardly. Preferably, only the terminal corrugation 96 located on the end portion 52 of the second pipe section 14 is flared outwardly. The degree to which the terminal corrugation 96 is flared outwardly is such that it does not appreciably increase the outside diameter 18 of the assembly 10. The flared terminal corrugation 96 facilitates receiving the first pipe section 12.

In accordance with the provisions of the patent statutes, the present invention has been described in what is considered to represent its preferred embodiment, however, it should be noted that the invention can be practiced otherwise that as specifically illustrated and described without departing from its scope or spirit.

What is claimed is:

1. A pipe joint assembly, comprising:
a first pipe section having double wall corrugations of a first height on a first portion and at least one double wall corrugation of a second height located on an end portion; and
a second pipe section having double wall corrugations of a first height on a first portion and at least one double wall corrugation of a second height located on an end portion;
wherein said first pipe section end portion is located in an overlapping orientation with said second pipe section end portion to form a joint between said sections.

2. The pipe joint assembly of claim 1, wherein said first pipe section has a first portion and an end portion.

3. The pipe joint assembly of claim 1, wherein said second pipe section has a first portion and an end portion.

4. The pipe joint assembly of claim 2, wherein said first portion and said end portion of said first pipe section are connected by a first wall.

5. The pipe joint assembly of claim 4, wherein said first wall has a substantially constant radius.

6. The pipe joint assembly of claim 5, wherein a plurality of corrugations are integrally formed with said first wall and extend radially outward from said first wall to form a second wall.

7. The pipe joint assembly of claim 6, wherein at least one corrugation is located proximate said end portion of said first section.

8. The pipe joint assembly of claim 7, wherein a plurality of corrugations are located proximate said end portion of said first section.

9. The pipe joint assembly of claim 1, wherein said second height corrugations are shorter than said first height corrugations.

10. The pipe joint assembly of claim 9, wherein said second height corrugations are approximately one half the height of said first height corrugations.

11. The pipe joint assembly of claim 3, wherein said first portion and said end portion of said second section are connected by a third wall.

12. The pipe joint assembly of claim 11, wherein said third wall, proximate said first portion, has a substantially constant inside radius.

13. The pipe joint assembly of claim 11, wherein a plurality of corrugations are integrally formed with said third wall and extend radially outwardly from said third wall to form a fourth wall.

14. The pipe joint assembly of claim 13, wherein at least one corrugation is located proximate said end portion of said second section.

15. The pipe joint assembly of claim 14, wherein a plurality of corrugations are located proximate said end portion of said second section.

16. The pipe joint assembly of claim 1, wherein said corrugations of said first portions of said first and second sections are substantially identical.

17. The pipe joint assembly of claim 1, wherein said corrugations of said end portions of said first and second sections are substantially identical.

18. The pipe joint assembly of claim 1, wherein a transition is located between said first portion and said end portion of said second section, said transition displacing said end portion of said second section radially outward said end portion of said first section.

19. The pipe joint assembly of claim 1, wherein said end portion of said second section frictionally overlaps said end portion of said first section.

20. The pipe joint assembly of claim 19, wherein said corrugations of said end portion of said second section overlap said corrugations of said end portion of said first section.

21. The pipe joint assembly of claim 2, wherein said first pipe section, said joint and said second pipe section have a substantially constant outside radius in an engaged orientation.

22. The pipe joint assembly of claim 2, wherein said first pipe section, said joint and said second pipe section have a substantially constant inside radius in an engaged orientation.

23. The pipe joint assembly of claim 2, wherein at least one gasket is located between said first and second sections.

24. The pipe joint assembly of claim 23, wherein said at least on e gasket makes said joint silt tight.

25. The pipe joint assembly of claim 23, wherein said at least one gasket makes said joint water tight.

26. The pipe joint assembly of claim 23, wherein said at least one gasket is an elastomeric O-ring.

27. The pipe joint assembly of claim 2, wherein said first and said second pipe sections and said joint are substantially constructed of polyethylene.

28. The pipe joint assembly of claim 2, wherein said first and said second pipe sections and said joint are substantially constructed of polyvinylchoride.

29. The pipe joint assembly of claim 2, wherein said first and said second pipe sections and said joint are substantially constructed of polypropylene.

30. The pipe joint assembly of claim 2, wherein said first and said second pipe sections and said joint are substantially constructed of polyolefins.

31. The pipe joint assembly of claim 2, wherein said end portion of said second pipe section has a terminal corrugation which is flared outwardly.

32. The pipe joint assembly of claim 31, wherein said outwardly flared terminal corrugation does not substantially increase the outside diameter of said pipe joint assembly.

33. The pipe joint assembly of claim 31, wherein said outwardly flared terminal corrugation facilitates receiving said first pipe section.
